(19) United States
(12) Patent Application Publication
(10) Pub. No.: US 2019/0061664 A1
(43) Pub. Date: Feb. 28, 2019

(54) METHOD FOR PROTECTING AT LEAST ONE OCCUPANT OF A MOTOR VEHICLE

(71) Applicant: Robert Bosch GmbH, Stuttgart (DE)

(72) Inventor: Johannes Ludwig Foltin, Ditzingen (DE)

(21) Appl. No.: 16/052,990

(22) Filed: Aug. 2, 2018

(30) Foreign Application Priority Data
Aug. 22, 2017 (DE) 102017214613.3

(51) Int. Cl. B60R 21/01; G07C 5/08

(52) U.S. Cl. CPC B60R 21/01; G07C 5/0808; B60R 22/46; B60R 2021/01184; B60R 2021/01129; B60R 2021/01006

(57) ABSTRACT

A method for protecting at least one occupant of a motor vehicle, including a) monitoring at least one electronic system of the motor vehicle, and b) outputting a signal for adapting at least one parameter which predefines a state of a particular reversible restraint system for the at least one occupant in response to a system error detected in the monitoring according to step a).

### CROSS REFERENCE

The present application claims the benefit under 35 U.S.C. § 119 of German Patent Application No. DE 102017214613.3 filed Aug. 22, 2017, which is expressly incorporated herein by reference in its entirety.

### BACKGROUND INFORMATION

Modern motor vehicles regularly include seat belts including seat belt tighteners and/or belt force limiters. Meanwhile, conventional active seats carry out an active response in the case of an accident or a system failure. Seat belt tighteners, belt force limiters, and active seats of this type are all “active restraint systems.” In particular, the seat belt tighteners and/or the belt force limiters may be activated during an accident, whereby particularly good protection of occupants with the aid of the seat belt may be achieved. The seat belt tighteners and/or the belt force limiters are regularly triggered via sensors. In conventional systems, a triggering of the seat belt tighteners and/or the belt force limiters is regularly not possible during a failure of the sensors, a corresponding electronics system, and/or the entire vehicle electrical system. When a possible accident is imminent and a system failure has been detected, the occupant may then be brought into a favorable position with the aid of the described restraint systems. For example, an upright position may be effectuated. In the case of active seats, this may take place, for example, due to the fact that the seat may be moved rearward in order to gain as much time as possible for deceleration with the aid of the seat belt. By adapting the sitting position, the belt force limiter, and the seat belt tightener, the occupant may be brought into a position which is ideal in an actual specific accident which has not yet been predicted.

### SUMMARY

A particularly advantageous method for protecting at least one occupant of a motor vehicle is presented here. Advantageous refinements of the method are described herein.

The described motor vehicle preferably includes a seat belt at each of the seats for the occupants (preferably at all seats). The seat belt may be attached to the vehicle, for example, to the B-pillar or the C-pillar, or may be integrated, for example, in the seat. For particularly good protection of the occupant, in particular during an accident, preferably at least one parameter may be set, which predefines a state of at least one reversible restraint system, in particular of a seat belt and/or a seat. The described method is directed, in particular, to the precautionary adjustment of the state of the seat belt and/or the seat, so that the state of the seat belt and/or the seat has already been set as desired when an accident subsequently occurs. The state therefore does not need to be adapted only when an accident is detected. A detection of the accident is therefore not necessary. Therefore, particularly good protection of the occupants may be achieved with the aid of the described method even when an error occurs in the electronics system of the motor vehicle. This also applies, in particular, for errors, due to which a detection of an accident is at least intermittently not possible. In order to detect system errors of this type, in particular, at least one electronic system of the motor vehicle is monitored in step a) of the described method.

Every component, every control unit, and every electronic circuit of the motor vehicle, in particular, is considered to be the at least one electronic system. The monitoring of the at least one electronic system preferably takes place electronically. This may take place, in particular, by way of the at least one electronic system itself. Alternatively or additionally, the at least one electronic system may be connected to a monitoring element including an appropriate electronics system.

During the monitoring, system errors of the at least one electronic system, in particular, may be detected. Any malfunction is considered to be a system error. For example, a system error may be due to a complete or partial failure of the electronic system. A fault current (which is caused, for example, by a short circuit) may also be a system error. In addition, system errors may be detected with the aid of sensors, in that particular measuring variables outside a corresponding predefinable tolerance range are measured.

In step a), such electronic systems are preferably monitored, in particular, for the presence of the type of system errors which, during an accident, may prevent an adjustment of the seat belt and/or the seat or make it difficult to adjust the seat belt and/or the seat for the particularly good protection of the occupant even before contact is made. Such electronic systems include, for example, surroundings sensors which are necessary both for the vehicle guidance and for the accident prediction, and control units involved therein. Due to the described method, particularly good protection of the occupants may be achieved despite a system error. Moreover, it is possible that the driver has the perception of enhanced safety due to the activation of reversible protective measures despite system errors, which may positively affect the driving experience.

For this purpose, in step b) of the described method, a signal for adapting at least one parameter is output, the parameter predefining a state of a particular reversible restraint system, in particular of the seat belt, for the at least one occupant. The output of the signal takes place in response to a system error detected in the monitoring according to step a).

A system error may prevent the adjustment of the state of the seat belt in the so-called “pre-crash phase” when an accident is imminent. Finally, a system error may prevent sensors (in particular, surroundings sensors for monitoring the surroundings of the motor vehicle) from operating correctly. The surroundings sensors may, in fact, no longer predict an accident. As a result, functions for protecting the occupants may not operate or, at least, may no longer operate correctly and, as a result, it may not be possible to prepare the occupants for the accident. Such functions for protecting occupants normally take place in the “pre-crash phase.” In terms of time, the pre-crash phase describes, for example, a period of time before the accident, usually a period of time of approximately 2 seconds immediately before the accident event. In this case, an accident event is usually considered to be the (first) contact with the accident opponent. During this time, the seat belt tightener is normally tightened and, for example, the seat is brought into a good position. Such a good position of the seat for an accident is also referred to as the “crash position” of the seat. By way of an adjustable (active) seat, it is possible, for example, to place the occupant far away from the dashboard and to appropriately adapt the belt force limiter and the airbag trigger point. In order to ensure that the occupant may nevertheless be protected particularly well during an accident, the state of the seat belt may be adapted, as a precautionary measure, by way of step b) when a system error has been detected according to step a). This takes place by way of the output of the signal for adapting the state of the seat belt. The signal may be output, in particular, by a control unit which is intended and configured for carrying out the described method. Preferably, this is carried out using the same control unit which was also used for step a).

By way of the output of the signal in step b) and by way of a subsequent adaptation of the state of the seat belt, the occupant may be brought into a sitting position, as a precautionary measure, for example, which is particularly favorable for an accident (so-called pre-crash positioning). If an accident subsequently actually takes place, the occupant is already situated in the particularly favorable sitting position. A detection of the specific accident and a subsequent adaptation of the sitting position of the occupant (in particular by changing the state of the seat belt) is therefore not necessary and could not have been reliably predicted, for example, in the case of failure of at least one portion of the surroundings sensors. Simultaneously, the risk of an accident usually also increases when system errors occur. Therefore, the occupant may be particularly well protected during an accident despite the system error by way of action having been taken before the detection of a specific accident.

The output of the signal according to step b) and the subsequent adaptation of the state of the seat belt take place in response to the detection of a system error. This means, there is a causal relationship between the output of the signal and the detection of the system error. If the state of the seat belt is changed, for example, anyway, at various points in time or continuously, this is not an adaptation within the scope of step b) when this temporally coincides with a system error. An adaptation in step b) is present only when the adaptation actually takes place in response to the detection of a system error.

In one preferred specific embodiment of the method, the at least one electronic system of the motor vehicle monitored according to step a) is at least partially configured for automated driving.

For automated driving, the surroundings of the motor vehicle may be detected, in particular, via a plurality of sensors and with the aid of an appropriate electronic system. An automated control of the motor vehicle may be carried out by referring to data gathered in this way. The sensors for automated driving may also be utilized, in particular, for detecting a collision which is impending or which has already taken place. If the electronic system for automated driving completely or partially fails, the detection of an, in particular, still impending collision may be made considerably more difficult or even impossible. Therefore, in this specific embodiment, the state of the seat belt is adapted (as a precautionary measure) by way of the signal from step b) in the case of a system error in the electronic system for automated driving, which has been detected according to step a). Since the likelihood of becoming involved in an accident without the accident having been detected is increased in the case of a system error in the electronic system for automated driving, the seat belt and other, in particular, reversible restraint systems may be adapted to a possible dangerous situation in this way. The automation of the motor vehicle may be a semi, high, or full automation. Consequently, only individual driving tasks, such as the lateral and/or longitudinal control or more complex driving tasks up to fully-automated driving may be taken over.

The electronic system for automated driving preferably includes a fallback support, in which the motor vehicle is in a safe state. When a system error occurs in a conventional motor vehicle (which is not configured for automated driving), the entire electronics system, in particular, may fail. Since a motor vehicle must be able to rely exclusively on the electronics system in order to implement automated driving, such a motor vehicle preferably includes more than one vehicle electrical system. As a result, at least one subset of the electronic components may continue to be operated in the case of a system error. As a result, the motor vehicle may be driven in a safe state on its own and without intervention by the driver.

During driving with the aid of the fallback support, all sensors/actuators are no longer (fully) available, depending on the failure. Situations may therefore arise, in which the motor vehicle is involved in an accident, in particular, without the accident having been detected. Due to the possibly failed sensor system, accidents may no longer be meaningfully predicted. In particular, a prediction of a possible collision may not take place with the aid of sensors, and so the occupants may not be appropriately prepared for an impending collision. For example, in particular, a pre-crash positioning functionality which activates reversible restraint systems on the basis of surroundings sensor signals may be omitted.

In yet another preferred specific embodiment of the method, the output of the signal takes place in step b) when, in particular, at least one of the following system errors has been detected in the monitoring according to step a):
a failure of a sensor,
a loss of sensitivity of a sensor,
a failure of a vehicle electrical system,
a failure of a control unit,
a failure of an actuator,
a transition of the at least one electronic system into a safety state.

The output of the signal in step b) preferably takes place when, in particular, a type of system error has been detected in the monitoring according to step a) which may influence the adjustment of the seat belt for protecting the occupant during an accident.

Such a system error may be due, in particular, to the failure or the loss of sensitivity of a sensor. In the case of a loss of sensitivity, although the sensor has not completely failed, the sensor is nevertheless no longer or no longer completely sensitive. The loss of sensitivity of a sensor may also be referred to as “blindness” of the sensor because, in the case of a loss of sensitivity of the sensor, the surroundings may no longer be detected, or may be detected only in a limited way, with the aid of the sensor. Optical sensors may, for example, lose their sensitivity and abruptly go blind when the motor vehicle travels over a piece of tarpaulin or foil. An optical sensor may lose sensitivity, for example, due to rain, snow, dirt, ice, and sudden steam or fog, so that the vehicle surroundings may no longer be detected or may be detected only in a limited way.

A failure of the vehicle electrical system is to be understood, in particular, as a failure of a power supply. The failure extends, in particular, at least so far that an electronic component necessary for an adjustment of a seat belt in the event of an accident is not supplied or is insufficiently supplied with current. A failure of the vehicle electrical system may also be present due to the fact that a power supply to all electronic components of the motor vehicle fails, with the exception of the type of electronic components which are connected to a safety vehicle electrical system. In particular, a failure of the vehicle electrical system may be present when a battery of the motor vehicle delivers no voltage. The failure of a vehicle electrical system may result, in particular, in the failure of one or multiple sensors.

In the case, in particular, of a motor vehicle for automated driving, continued travel may be made difficult or even impossible due to a failure of the vehicle electrical system, a failure of one or multiple sensors, and/or a loss of sensitivity of one or multiple sensors. In particular, an intervention by the driver may become necessary.

The failure of a control unit may result in subsequent errors or subsequent partial shutoffs of functions. In this way, for example, in the case of a failure of an ESP control unit which processes sensor signals and, for example, yields an accurate speed, a failure of further functions such as an emergency braking function may be the result.

The failure of an actuator, in particular, an actuator which controls the vehicle movement, may result in the situation in which many near-accidents may no longer be mitigated and an elevated accident risk is imminent. Moreover, for example, the failure of a windshield wiper actuator in the rain may result in the situation in which the camera systems may only poorly perform measurements through the wet windshield and, as a result, may more poorly detect an imminent accident.

The at least one electronic system may be preferably transferred into the safety state during an error. The error may also be, in particular, one of the above-described system errors. In this regard, the transfer of the at least one electronic system into the safety state may be considered to be a consequence of a system error. It is also possible, however, to monitor, in step a), whether the electronic system has been transferred into the safety state. In this regard, the transfer of the electronic system into the safety state is also to be considered to be a system error which results in the output of the signal according to step b).

In yet another preferred specific embodiment of the method, the signal output in step b) is configured at least for adapting a setting of a particular seat belt tightener as the state of the corresponding seat belt.

The seat belt tightener is preferably intended and configured for tightening or shortening the corresponding seat belt. There are various possibilities for achieving a tightening or shortening of a seat belt, of which arbitrary possibilities may be implemented here. According to one embodiment variant, a seat belt tightener partially rolls up the rolled out portion of the seat belt again, which results in a shortening and, therefore, a tightening of the rolled out portion. According to yet another embodiment variant, a seat belt buckle (a connection point of the seat belt) is drawn slightly downward in the direction of the vehicle floor. As a result, a greater distance must be covered by the seat belt from the seat belt outlet or the anchoring point up to the seat belt buckle, whereby the seat belt may be curved forward to a lesser extent by the body of the occupant. This results in a tightening of the seat belt.

The shortening may be triggered, in particular, in the case of a detected collision. Due to the seat belt tightener, the occupant may be brought into a sitting position, in particular, during an accident, which is particularly favorable for the accident. In particular, so-called seat belt slack may be eliminated with the aid of the seat belt tightener. This means, the seat belt is tightened in such a way that the seat belt rests snugly against the occupant. The occupant may therefore not be initially accelerated, unbraked, during a collision, in particular, and only subsequently stopped by the seat belt. In the case of such a stopping with the aid of the seat belt, the occupant could become injured by the seat belt. Moreover, an early tightening of the seat belt is advantageous, since the occupant is therefore coupled to the vehicle early and therefore has more space for decelerating and, therefore, reducing kinetic energy than is the case with seat belt slack and a subsequent coupling.

Preferably, the seat belt tightener is tightened to such an extent in the presence of a system error that the seat belt slack is eliminated. Therefore, the seat belt slack may be eliminated as a precautionary measure when, due to the system error, a triggering of the seat belt tightening by the seat belt tightener is possibly prevented during an accident. In this way, the occupant may be protected against an injury due to the seat belt slack, even despite the system error. The occupant may also be brought into a particularly well protected sitting position, as a precautionary measure, by way of the seat belt tightener and/or seat adjuster.

The seat belt tightener is preferably tightened slightly more at the beginning (i.e., immediately after the detection of a system error), so that the occupant may be brought into a particularly well protected sitting position. In this way, in particular, a distance between the occupant and a structure situated ahead of the occupant, such as a dashboard or another seat, may also be increased.

Preferably, a sitting position of the occupant is monitored (for example, with the aid of an interior camera). In this case, the seat belt tightener may be adjusted in step b), in particular as a function of a detected sitting position. In this way, it may be achieved that, due to a seat belt tightening by way of the seat belt tightener, an elevated seat belt force is applied only for as long as it takes for the occupant to sit in a desired sitting position. Subsequent thereto, the seat belt tightening may be slightly released again.

Preferably, the output of the signal according to step b) and the subsequent adaptation of the setting of the seat belt tightener take place in such a way that the occupant is prepared for a potential accident, an adverse effect on the occupant (for example, due to a sudden strong tightening of the seat belt) also being avoided. A low force effect by the seat belt may even be positively assessed by an occupant, since this force effect may impart a sense of security.

In yet another specific embodiment, the seat belt tightener is tightened to a lesser extent during the detection of a system error than during the detection of an immediately impending collision. As a result, the seat belt slack may be at least partially eliminated and, simultaneously, the occupant is not disturbed by a strong, apparently unnecessary tightening of the seat belt. The slight tightening may be considered to be a type of compromise between comfort and safety. Due to the weaker tightening, the seat belt may also be held tightened for a longer time, since the occupant is less restricted than in the case of a stronger tightening and, simultaneously, the point in time of a possible accident may not be predicted precisely enough.

In yet another preferred specific embodiment of the method, the signal output in step b) is configured at least for adapting a setting of a particular belt force limiter as the state of the corresponding seat belt.

With the aid of the belt force limiter, the maximum force acting on an occupant by way of the seat belt during an accident may be limited. In the case of the belt force limiter under consideration here, this maximum force may be adjusted. This may take place one time, for example, when the motor vehicle is switched on and/or upon detection of a change in a seat occupancy. In this case, the maximum force may be adapted, in particular, to a detected occupant, in particular, according to so-called occupant classes. In this way, the maximum force may be selected to be less for children, for example, than for adults.

Moreover, an adaptation of the maximum force to a detected distance between an occupant and, for example, a dashboard, may take place. This is meaningful, in particular, when a specific dangerous situation has been detected. If the belt force limiter is not adapted continuously, but rather only in specific dangerous situations, wear of the belt force limiter may be reduced. In the present specific embodiment, the output of the signal and the subsequent adaptation of the belt force limiter take place as part of the state of the seat belt, in particular, in the case of a system error detected according to step a).

Preferably, the belt force limiter is adapted, in particular, as a function of detected (for example, with the aid of an interior camera) properties of the particular occupant in this case. Such a property is considered to be, in particular, a body size, a body mass, and a sitting position. In particular, the adaptation may take place with reference to a distance between the occupant and, for example, a dashboard.

In yet another preferred specific embodiment, the output of the signal in step b) takes place, in particular, when at least one failure and/or one loss of sensitivity of an interior camera has been detected as a system error.

The interior camera may fail, for example, when the interior camera is connected to a failed vehicle electrical system and is electrically supplied by this vehicle electrical system. The interior camera may also lose sensitivity. This may be the case, for example, when brightness conditions abruptly change (for example, when the motor vehicle travels out of a tunnel into the open) or when an electrical connection is disconnected, for example, due to vibrations, or when the lens fogs up, for example, due to an increase in the atmospheric humidity in the interior space.

In this specific embodiment, in the case of a failure or a loss of sensitivity of the interior camera, as the system error, a distance of the occupant from a structure (such as a dashboard or a seat) situated ahead of the occupant is estimated, preferably in a model-based manner. This may take place, in particular, in such a way as if the motor vehicle did not include an interior camera. For example, the belt force limiter may be initially set to be particularly strong after detection of the system error of the interior camera and to be weaker after a certain (predefinable) time, when it is to be assumed that the occupant is sitting in a better protected position.

In yet another preferred specific embodiment of the method, an adaptation carried out due to step b) is at least partially undone as soon as the motor vehicle is in a safe state.

The safe state may be present, in particular, when an electronic system for automated driving (in particular, an autopilot) and/or a drive engine of the motor vehicle is shut off and/or when the motor vehicle is at a standstill. In particular, a safe state of the motor vehicle may be present when no highly dynamic driving maneuvers are to be expected and/or are possible. The safe state is to be distinguished, in particular, from the above-described safety state which is to be considered to be a system error.

If such a safe state is detected, a belt tightening by the seat belt tightener effectuated, in particular, by way of step b), may be at least partially undone, i.e., released. This may take place, in particular, after a predefined waiting time after detection of the system error or adaptation of the setting of the seat belt tightener. By way of the subsequent (at least partial) release of the seat belt tightening, the adverse effect on the occupant may be reduced by way of the adaptation of the setting of the seat belt tightener. Preferably, however, the seat belt remains at least partially tightened by the seat belt tightener, so that the adaptation according to step b) is to be considered to be only partially undone in this case. The adaptation according to step b) may also be completely undone, however, after the waiting time has elapsed. This means, in particular, that the tightening effectuated according to step b) is completely undone by the seat belt tightener.

The undoing of an adaptation carried out due to step b) may take place, in particular, by way of a corresponding signal being output by the control unit. Alternatively or additionally, the output of the signal output according to step b) may be changed or completely terminated.

In yet another preferred specific embodiment of the method, the output of the signal in step b) takes place at least as a function of a surroundings monitoring of the motor vehicle.

The surroundings monitoring may be directed, in particular, to detecting potential collision opponents, in particular, ahead of and/or behind the motor vehicle.

When the surroundings of the motor vehicle on a front side of the motor vehicle may no longer be detected or may be detected only in a limited way (for example, due to a partial system failure and/or a blindness of corresponding sensors), the output of the signal in step b) and a subsequent adaptation of the state of the seat belt take place preferably as a function of a traffic situation ahead of the motor vehicle detected before the occurrence of the system error. For this purpose, with regard to the output of the signal according to step b), for example, a time period between various strong seat belt tightenings by the seat belt tightener may be selected as a function of the most recently detected traffic situation ahead of the motor vehicle. In particular, the point in time may be selected, in this case, at which the seat belt tightener is slightly released again after an initial strong tightening.

Alternatively or additionally, the belt force limiter may be adapted as a function of the most recently detected traffic situation ahead of the motor vehicle. The belt force limitation preferably takes place, in particular, as a function of an expected collision impulse. A great belt force limitation is preferred, for example, when the motor vehicle is likely to hit a fixedly anchored object such as a bridge abutment or a tree. A lesser belt force limitation may be sufficient when a collision with a lightweight, non-anchored object such as a small car is imminent.

In particular, the output of the signal in step b) preferably takes place as a function of a possible collision impulse. If a potential accident opponent which would induce a high collision impulse (which is the case, for example, with a bridge abutment or a truck) was located ahead of the motor vehicle, for example, before the presence of the system error, a correspondingly high force level is preferably set with regard to the seat belt tightener and/or with regard to the belt force limiter. If an accident does then occur, the occupant has better chances of getting through the accident unharmed. The seat belt tightener may tighten the seat belt, in this case, in particular, with a greater force and/or for a longer time period, whereby there is a high likelihood that the occupant is already sitting in a particularly well protected position in the event of an actual collision.

However, if a potential accident opponent which would induce a particularly small collision impulse (which is the case, for example, with a small car or a motorcycle) was detected ahead of the motor vehicle before the presence of the system error, a correspondingly low force level is preferably set with regard to the seat belt tightener and/or with regard to the belt force limiter. If an accident then occurs, the seat belt slack may have already been eliminated with the aid of the seat belt tightener, which may be advantageously reflected in the so-called “ride-down space” (i.e., the distance between the occupant and, for example, a dashboard) for the deceleration. The small collision impulse to be anticipated may be fully utilized by a belt force limitation which was set to be low, which may result in low load values with regard to the occupant.

Possible collision opponents behind the motor vehicle may also be taken into account during the adaptation according to step b). This may take place alternatively or in addition to the taking into account of the traffic situation ahead of the motor vehicle.

In this way, for example, the duration for a seat belt tightening may be extended when another traveling motor vehicle was detected behind the motor vehicle before the presence of the system error. In this case, in particular, a relative speed and/or a distance between the motor vehicles may be taken into account. As a result, the occupant may be held in position long enough with the aid of the seat belt even in the case of a corresponding system error, so that the occupant is protected in the case of a rear-end collision despite the system error.

If the system error relates to only a portion of the sensor system, it is possible, in particular, that the adaptation according to step b) takes place dynamically and, in particular, as a function of sensor data which are still available. If, for example, a non-critical situation is detected before the presence of the system error, a change in the traffic situation (for example, a lane-changing truck) may be detected after a partial system failure with the aid of the still-functioning sensor system. When it may be reliably detected with the aid of the remaining sensors that a change in the situation did not take place, an activation of the reversible restraint systems, for example, the seat belt tightener, may not take place.

As yet another aspect, a control unit for a motor vehicle is presented, which is configured for carrying out the described method. The particular advantages and embodiment features described further above for the method are usable on and transferrable to the control unit.

Moreover, a computer program is presented, which is configured for carrying out all steps of the described method. In addition, a machine-readable memory medium is presented, on which the described computer program is stored. The particular advantages and embodiment features described further above for the method and the control unit are usable on and transferrable to the computer program and the machine-readable memory medium.

Further details of the present invention and one exemplary embodiment, to which the present invention is not limited, however, are explained in greater detail with reference to the figures.

### BRIEF DESCRIPTION OF THE DRAWINGS

FIG. 1 shows a representation of a motor vehicle which is configured for carrying out a method for protecting at least one occupant of the motor vehicle.

FIG. 2 shows a first representation of the method for protecting at least one occupant of the motor vehicle from FIG. 1.

FIG. 3 shows a second representation of the method from FIG. 2.

### DETAILED DESCRIPTION OF EXAMPLE EMBODIMENTS

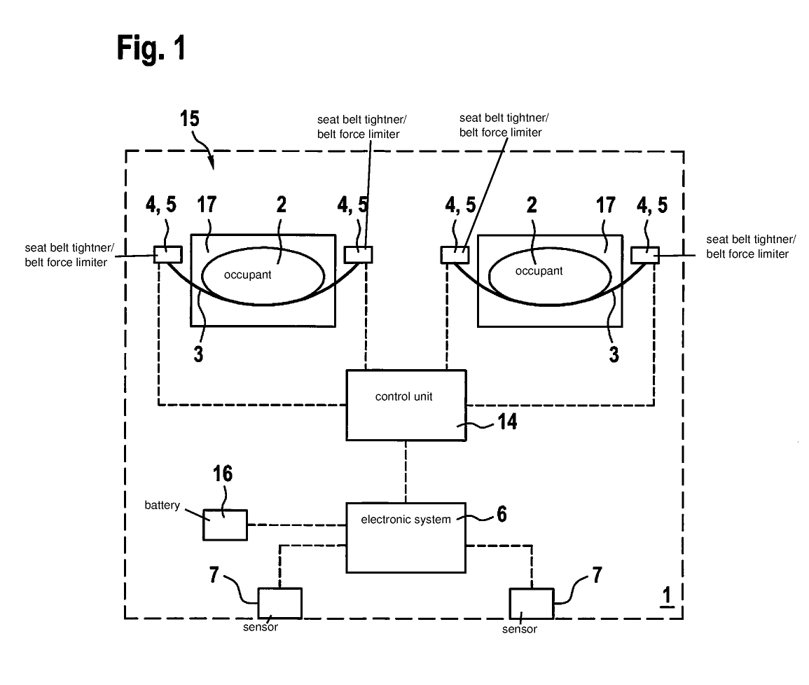

FIG. 1 shows a motor vehicle 1 including two occupants 2 on corresponding seats 17. Each of the occupants 2 is buckled up with a seat belt 3. Seat belts 3 each include seat belt tighteners 4 and belt force limiters 5.

Motor vehicle 1 includes an electronic system 6 which is connected to two sensors 7 and one battery 16. Electronic system 6, sensors 7, and battery 16 belong to a vehicle electric system 15. Electronic system 6 may be configured, in particular, for automated driving. In particular, for this case, surroundings of motor vehicle 1 may be detected with the aid of sensors 7.

Electronic system 6 is connected to a control unit 14 which is configured for carrying out a method for protecting occupants 2. For this purpose, control unit 14 is connected to electronic system 6 in such a way that electronic system 6 may be monitored by control unit 14, where, in particular, a system error of electronic system 6 may be detected by control unit 14. In this case, control unit 14 may output signals which are configured for adapting at least one parameter, the at least one parameter predefining a state of a particular seat belt 3 for occupants 2. The output of such a signal and a subsequent adaptation of a state of seat belt 3 take place in response to a system error detected in the monitoring of electronic system 6. In particular, control unit 14 may transmit signals for adapting seat belt tighteners 4, belt force limiters 5, and/or a seat 17 to seat belt tighteners 4, belt force limiters 5, and/or a seat 17.

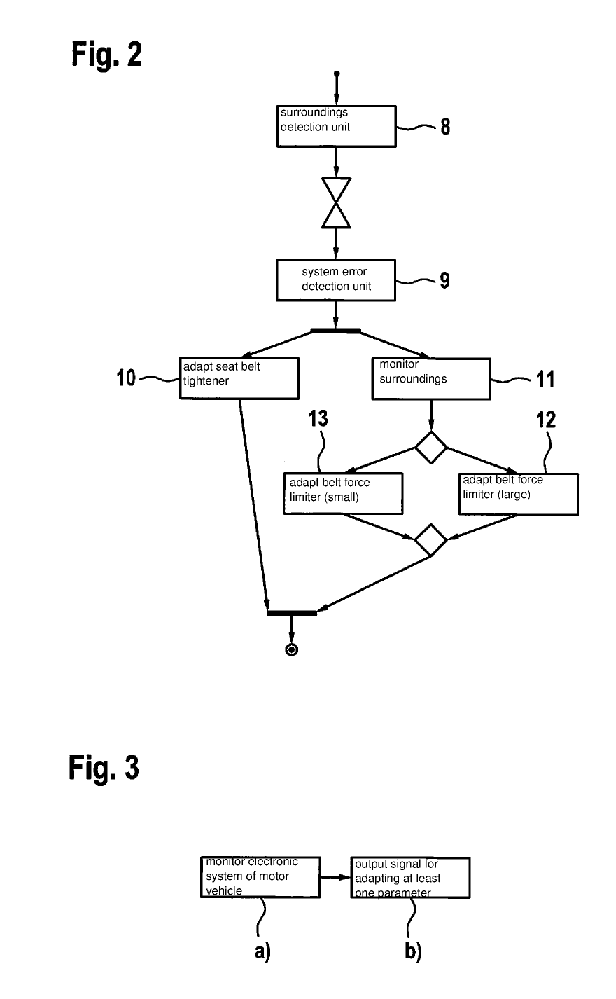

FIG. 2 shows a representation of the method for protecting occupants 2 of motor vehicle 1 from FIG. 1. If a system error of electronic system 6 is detected with the aid of a system error detection unit 9, an adaptation 10 of seat belt tighteners 4 may take place. In addition, an adaptation of belt force limiters 5 may be carried out. For this purpose, a small adaptation 13 of belt force limiters 5 or a large adaptation 12 of belt force limiters 5 may be carried out in a surroundings monitoring 11 according to a surroundings detection unit 8.

FIG. 3 shows yet another representation of the method from FIG. 2. It is apparent that the method includes the following steps:
a) monitoring an electronic system 6 of motor vehicle 1, and
b) outputting a signal for adapting at least one parameter which predefines a state of a particular seat belt 3 for occupants 2 in response to a system error detected in the monitoring according to step a).

What is claimed is:

1. A method for protecting at least one occupant of a motor vehicle, comprising:
a) monitoring at least one electronic system of the motor vehicle; and
b) outputting a signal for adapting at least one parameter which predefines a state of a particular reversible restraint system for the at least one occupant in response to a system error detected in the monitoring according to step a).

2. The method as recited in claim 1, wherein the at least one electronic system of the motor vehicle (1) monitored according to step a) is at least partially configured for automated driving.

3. The method as recited in claim 1, wherein the outputting of the signal takes place in step b) when at least one of the following system errors has been detected in the monitoring according to step a):
a failure of a sensor,
a loss of sensitivity of a sensor,
a failure of a vehicle electrical system,
a transition of the at least one electronic system into a safety state,
a failure of a control unit, and
a failure of an actuator.

4. The method as recited in claim 1, wherein the signal output in step b) is configured at least for adapting a setting of a particular seat belt tightener as the state of a corresponding seat belt.

5. The method as recited in claim 1, wherein the signal output in step b) is configured at least for adapting a setting of a particular belt force limiter as the state of a corresponding seat belt.

6. The method as recited in claim 1, wherein an adaptation carried out due to step b) is at least partially undone as soon as the motor vehicle is in a safe state.

7. The method as recited in claim 1, wherein the outputting of the signal in step b) takes place at least as a function of a surroundings monitoring of the motor vehicle.

8. A control unit for a motor vehicle, which is configured for protecting at least one occupant of the motor vehicle, the control unit configured to:
a) monitor at least one electronic system of the motor vehicle; and
b) output a signal for adapting at least one parameter which predefines a state of a particular reversible restraint system for the at least one occupant in response to a system error detected in the monitoring according to step a).

9. A machine-readable memory medium on which is stored a computer program for protecting at least one occupant of a motor vehicle, the computer program, when executed by a computer, causing the computer to perform:
a) monitoring at least one electronic system of the motor vehicle; and
b) outputting a signal for adapting at least one parameter which predefines a state of a particular reversible restraint system for the at least one occupant in response to a system error detected in the monitoring according to step a).
